(19) United States
(12) Patent Application Publication
(10) Pub. No.: US 2011/0298794 A1
(43) Pub. Date: Dec. 8, 2011

(54) CIRCULAR POLARIZED CONTACT LENSES AND METHODS THEREOF

(76) Inventor: Barney Freedman, Jacksonville, FL (US)

(21) Appl. No.: 13/153,566

(22) Filed: Jun. 6, 2011

Related U.S. Application Data
(60) Provisional application No. 61/352,634, filed on Jun. 8, 2010.

(51) Int. Cl. G06T 15/00; G02B 27/26

(52) U.S. Cl. 345/419; 359/465

(57) ABSTRACT

An apparatus and method for three-dimensional viewing that includes a first contact lens and a second contact lens of a pair. The first contact lens of the pair has a circular polarization filter in a clockwise direction or counterclockwise direction. The second contact lens of the pair has a circular polarization filter in the other one of the clockwise direction or the counterclockwise direction.

This application claims the benefit of U.S. Provisional Patent Application Ser. No. 61/352,634, filed Jun. 8, 2010, which is hereby incorporated by reference in its entirety.

### FIELD

This invention generally relates to contact lens and, more particularly, to circular polarized contact lenses for experiencing three-dimensional (3-D) environments and methods thereof.

### BACKGROUND

One widely used digital stereoscopic projection technology for watching 3-D movies in theatres employs circularly polarized light to produce stereoscopic image projection. Circular polarization technology has the advantage over linear polarization methods in that viewers are able to tilt their head and look about the theater naturally without a disturbing loss of 3-D perception. With linear polarization projection, viewers are required to keep their head orientation aligned within a narrow range of tilt for effective 3-D perception; otherwise they may see double or darkened images.

The projector used for this digital stereoscopic projection technology alternately projects right-eye frames and left-eye frames 144 times per second. It circularly polarizes these frames, clockwise for the right eye and counterclockwise for the left eye. A push-pull electro-optical liquid crystal modulator called a ZScreen is placed immediately in front of the projector lens to switch polarization.

To watch the movie in 3-D, audience members must wear special glasses with oppositely circularly polarized lenses to ensure each eye sees only its designated frame, even if the head is tilted. Unfortunately, these 3-D glasses often are not properly fitted to the viewer and uncomfortable to wear. Additionally, these improperly fitted 3-D glasses may cause some viewers to feel nauseated or experience a headache.

### SUMMARY

A three-dimensional viewing apparatus includes a first contact lens and a second contact lens of a pair. The first contact lens of the pair has a circular polarization filter in a clockwise direction or counterclockwise direction. The second contact lens of the pair has a circular polarization filter in the other one of the clockwise direction or the counterclockwise direction.

A method for making a three-dimensional viewing apparatus includes providing a first contact lens and a second contact lens of a pair. The first contact lens of the pair has a circular polarization filter in a clockwise direction or counterclockwise direction. The second contact lens of the pair has a circular polarization filter in the other one of the clockwise direction or the counterclockwise direction.

This technology provides a number of advantages including providing circular polarized contact lenses for experiencing three-dimensional (3-D) viewing environments, such as movies and gaming. Additionally, with this technology both active polarization and passive polarization can be implemented with the pairs of contact lens to permit three dimensional viewing.

### BRIEF DESCRIPTION OF THE DRAWINGS

FIG. 1 is a front elevational view of an exemplary passive, three-dimensional viewing apparatus;

FIG. 2 is a front elevational view of an exemplary active, three-dimensional viewing apparatus;

FIG. 3 is a block diagram of the exemplary active, three-dimensional viewing apparatus illustrated in FIG. 2; and

FIG. 4 is a flowchart diagram of an example of methods for making the exemplary three-dimensional viewing apparatus shown in FIGS. 1-3.

### DETAILED DESCRIPTION

This technology provides a pair of circular polarized contact lenses so consumers can experience a three-dimensional (3-D) environment, such as in a movie theater, on a 3-D television, on a 3-D computer monitor or a 3-D game console, without the need to wear 3-D glasses. Each of the contact lens comprises an optical structure, which is configured for placement on the cornea of the eye, although other types of arrangements could be used. In addition to three-dimensional viewing, these contact lenses also can be used for other purposes, such as corrective, cosmetic, or therapeutic. Each of the contact lens can be made from a variety of different types and numbers of materials, such as glass or silicone hydrogel by way of example only.

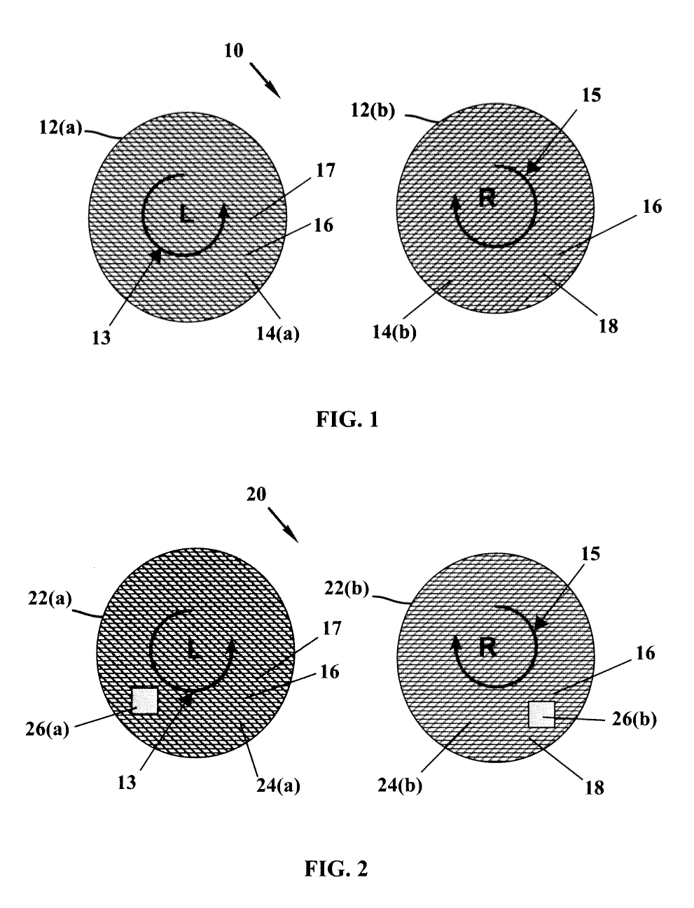

An exemplary pair 10 of passive polarization contact lenses 12(a)-12(b) is illustrated in FIG. 1. Each lens 12(a)-12(b) has a circular polarization filter 14(a) and 14(b), respectively is constructed of a quarter-wave plate and a linear polarizing filter producing in one of both a left-handed or counterclockwise direction 13 and right-handed or clockwise direction 15, one on each lens, to decode images so that each eye only sees that eyes intended image. Specifically, the left lens 12(a) includes circular polarization filter 14(a) having a quarter-wave plate 17, as illustrated by negative angled lines 17 and linear polarizing filter 16, as illustrated by horizontal lines 16. The right lens 12(b) includes circular polarization filter 14(b) having a quarter-wave plate 18, as illustrated by positive angled lines 18 and linear polarizing filter 16, as illustrated by horizontal lines 16. The circular polarization filters are configured to decode three-dimensional content. For example, a three-dimensional image or frame that is being sent to a person that has a circular polarization for the right eye in a clockwise manner and a counterclockwise for the left eye would be decoded by the contact lenses so that each eye had opposite polarization (counterclockwise and clockwise). As a result, the left eye only sees its intended image frames and the right eye only sees its intended images frames. The brain of the viewer processes and put the two images together creating the three-dimensional image.

The passive polarization contact lenses 12(a)-12(b) achieve their polarization properties in a passive mode. In a passive mode (as shown in the example in FIG. 1), the circular polarization filter in the pair 10 of contact lens 12(a)-12(b) remains constant and does not change. In an alternative example, the pair 20 of active polarization contact lens 22(a)-22(b) is active and changes in response to control signals.

More specifically, an alternative example of a pair 20 of active polarization contact lens 22(a)-22(b) is shown in FIG. 2. Like the passive polarization three dimensional contact lenses 12(a)-12(b), each of the active polarization lens 22(a)-22(b) includes a circular polarization filter 24(a) and 24(b), which is constructed of a quarter-wave plate and a linear polarizing filter producing in one of both a left-handed or counterclockwise direction 13 and right-handed or clockwise direction 15, one on each lens, to decode images so that each eye only sees that eyes intended image. Specifically, the left lens 22(a) includes circular polarization filter 24(a) having a quarter-wave plate 17, as illustrated by negative angled lines 17 and linear polarizing filter 16, as illustrated by horizontal lines 16. The right lens 22(b) includes circular polarization filter 24(b) having a quarter-wave plate 18, as illustrated by positive angled lines 18 and linear polarizing filter 16, as illustrated by horizontal lines 16.

Each of the active polarization contact lens 22(a)-22(b) also each includes one of the control devices 26(a)-26(b) imbedded or otherwise respectively coupled to one of the active polarization contact lens 22(a)-22(b) to control polarization therein. For example, control devices 26(a)-26(b) may send voltage signals to the filters that open and close or shutter circular polarization filters 24(a) and 24(b), respectively. In addition, by way of example, a nanocontrol device could provide a control signal that shutter the filters in the pair of active polarization contact lens 22(a)-22(b) at designated speed, although other types of control devices could be used and other combinations of passive and active filtering in a pair of contact lenses could be used.

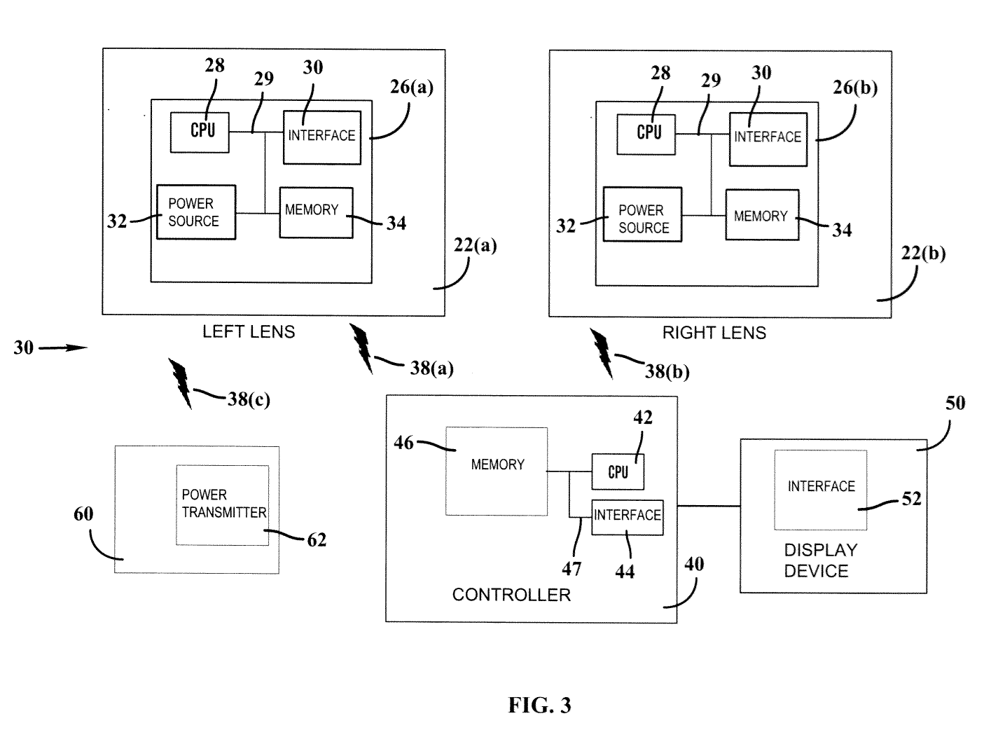

Referring to FIG. 3, a block diagram of a three-dimensional viewing apparatus 30 with the exemplary pair 20 of first and second active polarization contact lens 22(a)-22(b) shown and described with reference to FIG. 2, a controller 40, and a display device 50 is illustrated, although other numbers and types of devices, and/or elements in other configurations can be used.

Referring more specifically to FIG. 3, each lens 22(a)-22(b) is at least a partially translucent substrate, i.e., translucent to visible light and each have one of the control devices 26(a)-26(b), respectively coupled thereto. Each control devices 26(a)-26(b) includes a CPU 28, an interface device 30, a power source 32, memory 34, and interconnects or other links 29 that couple together the various components assembled on each lens 22(a)-22(b), although each control device could include other types and numbers of elements in other configurations.

The processor 28 in each of the control devices 26(a)-26(b) executes a program of stored instructions one or more aspects of the present invention as described and illustrated by way of the embodiments herein, although the processor could execute other numbers and types of programmed instructions.

The interface device 30 in each of the control devices 26(a)-26(b) is used to operatively couple and communicate between the control devices 26(a)-26(b) and the controller 40 and the display 50 via one or more communication links. By way of example only, the interface device 30 could comprise an antenna, which can use the exemplary wireless networks 38(a), and 38(b) via an infrared, radio frequency, DLP-Link, Bluetooth transmitter, or the like to communicate between controller 40 and control devices 26(a)-26(b). Although other types and numbers of communication links or networks can be used.

The power source 32 is adapted to power the control devices 26(a)-26(b) and any other components needing power in each of the active polarization contact lens 22(a)-22(b) using stored energy, e.g., a battery. By way of example, the power source 32 could be a rechargeable battery. Although other types and numbers of energy sources with other types and numbers of connections and configurations can be used. By way of example, the power source 32 could be a solar energy power source. Alternatively, in another illustrative example power source 32 could be configured to receive power via a wireless signal 38(c), for powering the components of each active polarization contact lens 22(a)-22(b). In this example, power supply 60 generates a wireless power signal and transmits the signal through power transmitter 62 to power source 32 that is integrally disposed within each active polarization contact lens 22(a)-22(b) to power the active elements on each lens. In addition, power supply 60 may be configured to recharge the power source 32 wirelessly. In this example, the power supply 60 may conveniently be worn by the user (for example, attached to a belt, integrated into the user's cloths, etc.) to keep the power supply 60 in close proximity to each active polarization contact lens 22(a)-22(b).

The memory 34 in control devices 26(a)-26(b) stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) that is coupled to the processor 28 can be used for the memory 34 in control devices 26(a)-26(b).

In this example, controller 40 includes CPU 42, interface device 44, and memory 46, which are coupled together by one or more interconnects or other links 47, although the controller can include other types and numbers of elements in other configurations. Controller 40 is configured to provide control instructions to coordinate active polarization of each active polarization contact lens 22(a)-22(b) with three-dimensional content being shown on display 50; although other types of function could be performed with other exchanges of data in either direction could be conducted.

The processor 42 in the controller 40 executes a program of stored instructions one or more aspects of the present invention as described and illustrated by way of the embodiments herein, although the processor could execute other numbers and types of programmed instructions.

Interface device 44 is used to operatively couple and communicate with interface 30 of the control devices 26(a)-26(b) and interface device 52 of the display over a communication link, although other types and numbers of communication links with other types and numbers of connections and configurations can be used. By way of example only, the communication link can use a wireless network 38(a) and 38(b) via an infrared, radio frequency, DLP-Link, Bluetooth transmitter, or the like to communicate between interface device 44 of the controller 40 and interface device 30 of the control devices 26(a)-26(b). In addition, by way of example, controller 40 may be constructed separate from or integral with the power supply 60. In addition, power transmitter 62 may also be utilized for transmitting and/or receiving data for the CPU 42. Alternatively, transmitter 62 may be used by the controller 40 for exchanging data and power with each active polarization contact lens 22(a)-22(b). Optionally, interface device 44 may include an antenna (not shown), which may be configured to couple with and communicate to an antenna coupled to each control devices 26(a)-26(b) for detecting and transmitting data/signals wirelessly.

The memory 46 in the controller 40 stores these programmed instructions for one or more aspects of the present invention as described and illustrated herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor 42, can be used for the memory 46 in the controller 40.

The display 50 is used in conjunction with each active polarization contact lens 22(a)-22(b) to provide the display of the three-dimensional image, such as a three-dimensional movie or a three-dimensional interactive video game by way of example. In this example, the active polarization contact lens 22(a)-22(b) are controlled by a wireless signal generated from controller 40. For instance, a timing signal can be transmitted to the control devices 26(a)-26(b) from controller 40 that allows the circular polarizing filters to alternately darken over one eye, and then the other, in synchronization with the refresh rate of the display 50. As a result, the display 50 by way of example alternately displays different perspectives for each eye, using a technique called alternate-frame sequencing, which achieves the desired effect of each eye seeing only the image intended for it. In another example, the combination of stereoscopic measurement and the optical flow between two consecutive images leads in addition to the temporal change of the spatial position, which results in 6D-vision. 6D-vision is also applied for perception of gestures, the motion of human limbs, without modeling the shape of persons with just using a passive stereo camera.

In this example, the display 50 can be any type of display that is capable of displaying stereoscopy technology. For example, a Liquid Crystal Display, computer display, plasma screen, a movie theater screen, a 3-D television, a 3-D computer monitor, a 3-D game console, or the like although other types and numbers of displays could be used.

Interface device 52 is used to operatively couple and communicate with interface 30 of the control devices 26(a)-26(b) and interface device 44 of the controller over a communication link, although other types and numbers of communication links with other types and numbers of connections and configurations can be used.

Alternatively, lens 22(a)-22(b) may include a sensor (not shown), disposed on the surface of the lens 22(a)-22(b). The sensors may be configured to sample and analyze the 3-D viewer's level of eye fluid, eye irritation, heart rate, or the like. Data received from the sensors are relayed back to the controller 40, which may be used to monitor chronic discomforts caused by 3-D viewing. Such as for example, eye fatigue from 3-D viewing, headaches, blurred vision, nausea, dizziness or the like.

As discussed earlier, the polarized contact lenses also could incorporate the viewer's eye prescription into the contact lens optical structure giving them a personalized three-dimensional viewing devise. With this example, the viewer would have corrected vision along with the existing capability to view a 3-D environment.

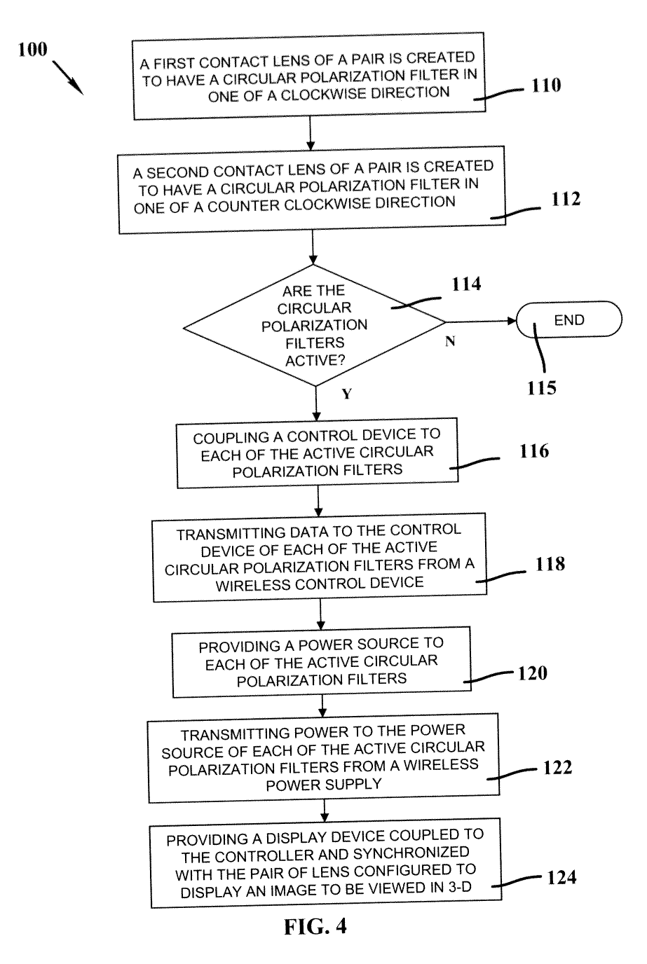

Referring to FIG. 4, an alternative embodiment of this technology is described. In this embodiment, an exemplary method for making the three-dimensional viewing apparatus comprising a first contact lens and a second contact lens of a pair is described using flowchart 100 with reference back to FIGS. 1-3.

In step 110, a first contact lens 12(a) of a pair is created to have a circular polarization filter 14(a) in a left-handed or counterclockwise direction 13, although a right-handed o clockwise direction could be used. As further illustrated in FIG. 1, each circular polarization filter 14(a) and 14(b) is constructed of a quarter-wave plate and a linear polarizing filter. For example, the left lens 12(a) is formed to include a circular polarization filter 14(a) having a quarter-wave plate 17, as illustrated by negative angled lines 17. The quarter-wave plate 17 is configured to receive and transform left-handed circularly polarized light into linearly polarized light, which has its direction of polarization along the transmission axis of the linear polarizing filter. In this example, the linear polarizing filter 16, as illustrated by horizontal lines 16, transmits the vertical components of the polarized light while the horizontal components are absorbed. As a result, light that is right-circularly polarized is blocked by the left-handed filter.

In step 112, a second contact lens 12(b) of a pair is created to have a circular polarization filter 14(b) in a right-handed or clockwise direction 15, although a left-handed or counterclockwise direction could be used. In contrast to the left lens 12(a), right-handed circularly polarized light is formed to have linearly polarized light by the right lens 12(b), which includes circular polarization filter 14(b) having a quarter-wave plate 18, as illustrated by negative angled lines 18. The quarter-wave plate 18 is formed to receive and transform right-handed circularly polarized light, into linearly polarized light, which has its direction of polarization along the transmission axis of the linear polarizing filter, i.e., blocks horizontal light. In this example, the linear polarizing filter 16 is formed, as illustrated by horizontal lines 16, to transmit the vertical components of the polarized light while the horizontal components are absorbed. As a result, left-circularly polarized light is blocked by the right-handed filter.

Each of the pairs 10 and 20 of contact lens 12(a)-12(b) and 22(a)-22(b) can be made from a variety of different types and numbers of materials, such as glass or silicone hydrogel by way of example only. Each of the pairs 10 and 20 of contact lens 12(a)-12(b) and 22(a)-22(b) are at least partially translucent to visible light, although the lenses could be constructed with other types of parameters.

In step 114, a determination is made whether a pair 20 of active polarization contact lens 22(a)-22(b) is being made. In a passive polarization mode, the circular polarization filter in the pair of contact lens 12(a)-12(b) remains constant and does not change. In an active polarization mode, the circular polarization filters in the pair 20 of contact lens 22(a)-22(b) is active and changes in response to control signals. If a pair 10 of passive polarization contact lens 12(a)-12(b) for three-dimensional viewing is being made, then the No branch is taken to step 115 where this method ends. If a pair 20 of active polarization contact lens 22(a)-22(b) for three-dimensional viewing is being made, then the Yes branch is taken to step 116. Although in this example steps 110 and 112 are shown as being the same for making the passive pair 10 and active pair 20, these steps for making the active pair 20 may differ so that the contact lens 22(a)-22(b) can provide active polarization for three-dimensional viewing.

In step 116, a control devices 26(a)-26(b) is coupled to each of the active circular polarization filters 24(a) and 24(b), respectively, wherein each of the control device receives control data for shuttering each of the active circular polarization filters in at least one of the first contact lens 22(a) and the second contact lens 22(b). By way of example, each of the active circular polarization filters 24(a) and 24(b) in lens 22(a)-22(b) may contain a liquid crystal layer, which has the property of becoming dark when voltage is applied while otherwise being transparent. As a result, the active circular polarization filters 24(a) and 24(b) alternately open and shut each 22(a)-22(b) to show each eye a different image. In the present example, control devices 26(a)-26(b) are impregnated or otherwise connected to each of the lens 22(a)-22(b) in such a manner that provides comfort for the user.

In step 118, a controller 40 is provided to transmit data to each of the control devices of each active circular polarization filter 24(a) and 24(b). By way of example, the data transmission can be via a wireless network. The wireless transmission can be via an infrared, radio frequency, DLP-Link, Bluetooth transmitter, or the like. The data exchanged between each active polarization contact lens 22(a)-22(b) and the controller 40 may include, for example, control signals that shutter the circular polarization filters in the pair of contact lens at designated speeds, sync data to the display 50, signals to refresh pixels in the display 50 to display the desired visual information, or the like.

In step 120, a power source 32 is coupled to each of the active circular polarization filters 24(a) and 24(b) of the active circular polarization contact lenses 22(a)-22(b).

In step 122, in this example a wireless power supply 60 and transmitter 62 is provided to transmit power to the power source 32 of each of the active circular polarization filters 24(a) and 24(b) of the active circular polarization contact lenses 22(a)-22(b), although manners for providing power, such as a local power source on each of the lens 22(a)-22(b) could be used. Additionally, other types and numbers of wireless and non-wireless energy transfer devices as well as other manners for supply power could be used.

In step 124, a display 50 is coupled to the controller, synchronized with the pair of lens, and configured to display an image to be viewed in 3-D.

Accordingly, as illustrated and described herein this technology provides a number of advantages including providing circular polarized contact lenses for experiencing three-dimensional (3-D) viewing environments, such as movies and gaming. Additionally, with this technology both active polarization and passive polarization can be implemented with the pairs of contact lens to permit three dimensional viewing.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A three-dimensional viewing apparatus comprising:
a first contact lens of a pair having a circular polarization filter in a clockwise direction or counterclockwise direction; and
a second contact lens of the pair having a circular polarization filter in the other one of the clockwise direction or counterclockwise direction.

2. The apparatus as set forth in claim 1 wherein at least one of the circular polarization filter in the first contact lens and the second contact lens and is a passive circular polarization filter.

3. The apparatus as set forth in claim 1 wherein at least one of the circular polarization filter in the first contact lens and the second contact lens and is an active circular polarization filter.

4. The apparatus as set forth in claim 3 further comprising a control device coupled to each of the active circular polarization filters, wherein the control device processes data for shuttering of each of the active circular polarization filters in at least one of the first contact lens and the second contact lens.

5. The apparatus as set forth in claim 1 wherein at least one of the first contact lens and the second contact lens is configured to correct vision.

6. The apparatus as set forth in claim 4 further comprising a controller device configured to transmit data to and receive data from the control device of at least one of the circular polarization filter in the first contact lens and the second contact lens.

7. The apparatus as set forth in claim 3 further comprising a power source coupled to each of the active circular polarization filters.

8. The apparatus as set forth in claim 7 further comprising a power supply configured to transmit power wirelessly to the power source of each of the circular polarization filters in the first contact lens and the second contact lens.

9. The apparatus as set forth in claim 3 further comprising a sensor coupled to each of the active circular polarization filters configured to transmit data regarding a user's discomforts caused by 3-D viewing.

10. The apparatus as set forth in claim 3 further comprising a display device coupled to the controller device and synchronized with the pair of lens configured to display an image to be viewed in 3-D.

11. The apparatus as set forth in claim 7 wherein the power source is a stored energy power source.

12. The apparatus as set forth in claim 7 wherein the power source is a solar energy power source.

13. A method for making a three-dimensional viewing apparatus, the method comprising:
providing a first contact lens of a pair having a circular polarization filter in one of a clockwise direction or a counterclockwise direction; and
providing a second contact lens of the pair having a circular polarization filter in the other one of the clockwise direction or the counterclockwise direction.

14. The method as set forth in claim 13 wherein at least one of the circular polarization filter in the first contact lens and the second contact lens and is a passive circular polarization filter.

15. The method as set forth in claim 13 wherein at least one of the circular polarization filter in the first contact lens and the second contact lens and is an active circular polarization filter.

16. The method as set forth in claim 15 further coupling a control device to each of the active circular polarization filters, wherein the control device controls shuttering of the active circular polarization filter in at least one of the first contact lens and the second contact lens.

17. The method as set forth in claim 13 wherein at least one of the first contact lens and the second contact lens is configured to correct vision.

18. The method as set forth in claim 15 further comprising transmitting data to the control device of at least one of the circular polarization filter in the first contact lens and the second contact lens from a wireless control device.

19. The method as set forth in claim 15 providing a power source to each of the active circular polarization filters.

20. The method as set forth in claim 19 further comprising transmitting power to the power source of at least one of the circular polarization filter in the first contact lens and the second contact lens from a wireless power supply.

21. The method as set forth in claim 15 coupling a sensor to each of the active circular polarization filters, wherein the sensors are configured to transmit data regarding a user's discomforts caused by 3-D viewing.

22. The method as set forth in claim 15 providing a display device coupled to the controller and synchronized with the pair of lens configured to display an image to be viewed in 3-D.
